(19) United States
(12) Patent Application Publication
(10) Pub. No.: US 2007/0136363 A1
(43) Pub. Date: Jun. 14, 2007

(54) SYSTEMS AND METHODS FOR REPORT DESIGN AND GENERATION

(75) Inventor: David Thielen, Boulder, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: WINDWARD STUDIOS, INC., Boulder, CO (US)

(21) Appl. No.: 11/671,388

(22) Filed: Feb. 5, 2007

Related U.S. Application Data
(62) Division of application No. 10/834,444, filed on Apr. 28, 2004.
(60) Provisional application No. 60/466,337, filed on Apr. 29, 2003.
(60) Provisional application No. 60/561,984, filed on Apr. 14, 2004.

(51) Int. Cl. G06F 7/00

(52) U.S. Cl. 707/102

(57) ABSTRACT

A system and method for generating reports from a data source using a word processing template having at least one field that expresses a command and at least one field that expresses a reference to the data source. A processor generates a report using the data source and the word processing template to define conditional text, layout, and formatting based on information determined at runtime.

### 1. RELATED APPLICATIONS

This Application is a divisional of U.S. patent application Ser. No. 10/834,444 filed Apr. 28, 2004, which claims the benefit of U.S. Provisional App. Ser. No. 60/466,337 filed on Apr. 29, 2003, and U.S. Provisional App. No. 60/561,984 filed Apr. 14, 2004. This Application is also related to U.S. Pat. App. Ser. No. ______ (Attorney Docket No. 349581), U.S. Pat. App. Ser. No. ______ (Attorney Docket No. 349582), and U.S. Pat. App. Ser. No. ______ (Attorney Docket No. 349584), filed on even date herewith, all of which are incorporated herein by reference.

### BACKGROUND OF THE INVENTION

1. Field of the Invention

The present invention relates, in general, to information processing, and, more particularly, to software, systems and methods for designing reports for presenting information from a database, and generating reports according to the designs.

2. Relevant Background

Reports remain a leading method of presenting data and information in a business environment. Reports typically draw selected data from a database, implement processes to arrange and organize that data, and present the results in printed form or on a display, or in another available format. Reports organize, synthesize, and summarize raw data to improve the ability to communicate that data to others. As such, the design and layout of a report is critical to the effectiveness of a report.

To succeed in today's business environment, an enterprise must manage the effects of several realities: the recent, massive investment in technology has significantly increased information technology (IT) complexity; the Internet has altered customers' expectations of availability, cost, and service; and the new economic climate highlights the need to leverage existing assets and improve the return on investment for new initiatives. This environment requires IT organizations to increase productivity and lower the cost of conducting business. A reporting infrastructure that provides more efficient report design, development, and deployment, is an increasingly essential need for building new applications, extending reporting in existing systems and integrating enterprise systems to achieve business value.

In many IT projects, reporting tends to be left until the end of a project. Suddenly, when it is time for the system to go live, the reporting module remains to be written. Reports can be individually created, however, this generally takes significant development effort. At the same time, development effort is needed for all the issues that arise as a system goes live. As a result, initial reporting modules often fail to meet the system needs and design goals, and hamper initial adoption of systems.

Existing report development tools tend to be single-purpose software environments that are unfamiliar to end-users. For example, many database management systems (DBMS) tend to include report design tools that are specific to the DBMS. More general purpose report design tools provide a user interface that is specifically adapted to report design, and so is unfamiliar to most end-users. As a result, report design remains a function of DBMS and IT experts.

Extensible markup language (XML) is increasingly used to manage and store data. XML standards define syntax for marking data with tags that describe the data. In this manner raw data is associated with its description, enabling the data to be readily exchanged and used by a variety of applications. Although XML data and markup are human-readable, XML does not itself define a format in which the data is presented. Hence, XML is useful for exchanging data between computer systems and software applications, but in order to form reports using XML data, software applications have to be developed to read and parse XML files as well as reformat the data into reports. In most cases it is at least as difficult to design, develop and deploy reports using XML data sources as has been the case with other (non-XML) data sources.

Current report design technologies tend to have another major issue: the people who use the reports generally don't create them. As a result, creating reports becomes an iterative process where the developer creates a report and shows it to the end user. The user may review and attempt to use a report, then provide feedback to the report developer. The developer takes the feedback from the end user, then refines the report. This iterative process is slow, expensive, and frustrating for all involved. This leads to inadequate reports because getting it right becomes too expensive.

Some software applications such as word processing software incorporate limited capability to present data from databases. For example, desktop word processing applications have templates and “mail-merge” functionality that enable data to be pulled into a template document from external data sources such as tables and a limited variety of databases. This functionality is designed primarily to enable the generation of form letters using small amounts of data and similar applications that are far less demanding than report generation software. Moreover, this type of functionality is intended to access special-purpose data sources that contain only the data that will be used for the form letter (e.g., an address list). In contrast, it would be desirable to use data from general-purpose or multi-purpose databases (e.g., an enterprise contact management database, sales/marketing database and the like) that can be queried to select specific data that will appear in a report, a capability that is lacking in current word processing applications.

As a result, the rich features implemented in word processing software that enable users to manipulate the presentation of information are not easily used to design reports. Users are constrained to use one of the limited variety of data sources that are provided by the word processing software. In particular, word processing application software is not able to draw data from XML data records and incorporate XML data records into documents.

Accordingly, a need exists for reporting software, systems, and methods that enable users to design reports using familiar software such as word processing application software while at the same time enabling the reports to access a wide variety of data sources such as databases such as SQL databases and proprietary databases, as well as XML records.

### SUMMARY OF THE INVENTION

Briefly stated, the present invention involves systems and methods for generating reports from a data source using a word processing template having at least one field that expresses a command and at least one field that expresses a reference to the data source. A processor generates a report using the data source and the word processing template to define conditional text, layout, and formatting based on information determined at runtime.

The present invention provides a fast and easy system to create, modify, and deliver reports. This enables the enterprise to improve profitability, maintains competitive advantage by adapting to change with increased agility, and improves productivity with better use of development resources. In particular implementations, the present invention uses Microsoft Word to lay out a report, providing end users with the capability to create a report template. This template is then populated with data to create a report in html, pdf, rtf, or txt format.

### BRIEF DESCRIPTION OF THE DRAWINGS

FIG. 1 shows a computer environment in which the present invention is implemented;

FIG. 2 shows an exemplary data source;

FIG. 3 illustrates an exemplary template file;

FIG. 4 illustrates an exemplary report generated in accordance with the present invention; and

FIG. 5 shows an implementation of a report server in accordance with the present invention.

### DETAILED DESCRIPTION OF THE PREFERRED EMBODIMENTS

The present invention is illustrated and described in terms of a distributed computing environment such as an enterprise computing system using public communication channels such as the Internet. However, an important feature of the present invention is that it is readily scaled upwardly and downwardly to meet the needs of a particular application. Accordingly, unless specified to the contrary the present invention is applicable to significantly larger, more complex network environments as well as small network environments such as conventional LAN systems and stand-alone computer systems.

The present invention provides a reporting module that can be implemented in a matter of days by one developer. This includes incorporating the report design system of the present invention into an existing database, information management system, or the like as well as designing and creating the reports themselves. The present invention eliminates the expense and frustration associated with iterative report development processes. Because the report is designed in a familiar word processor, such as Microsoft Word® such that anyone familiar with word processing can design their own reports. Because users are designing reports for themselves, they are more likely to design a report including the features and content that they desire, and do so quickly.

The present invention provides a fast and easy to operate system to create, modify, and deliver reports. This enables the enterprise to improve profitability, maintains competitive advantage by adapting to change with increased agility, and improves productivity with better use of development resources.

In a particular implementation, the present invention uses a familiar word processor such as Microsoft Word, Corel WordPerfect, ThinkFree Office, Star Office, Lotus WordPro, and the like (or any other word processor that can save in rtf format) to lay out a report. Hence, the present invention leverages all of the functionality and features of commercial word processing programs to implement a user interface. This provides end-users with the capability to create a report template. A powerful wizard assists in inserting data tags in into the report templates. In this manner, an end user who is familiar with creating basic word processing documents can become a report designer, eliminating the need for someone who is dedicated to report design functions.

Preferably the present invention uses industry standards. Report design is via Microsoft Word, for example, and the invention is implemented in software written in the Java Programming Environment™. Data tags are written in XPath, a standard for identifying extensible markup language (xml) elements. In particular implementations, the present invention publishes reports in a variety of industry standard formats including hypertext markup language (html), portable document format (pdf), rich text format (rtf), and text format. HTML reports can be created with or without cascading style sheets. The present invention easily integrates into an existing enterprise system, integration can be as simple as a single API call that passes two streams in and gets the report back in a third stream.

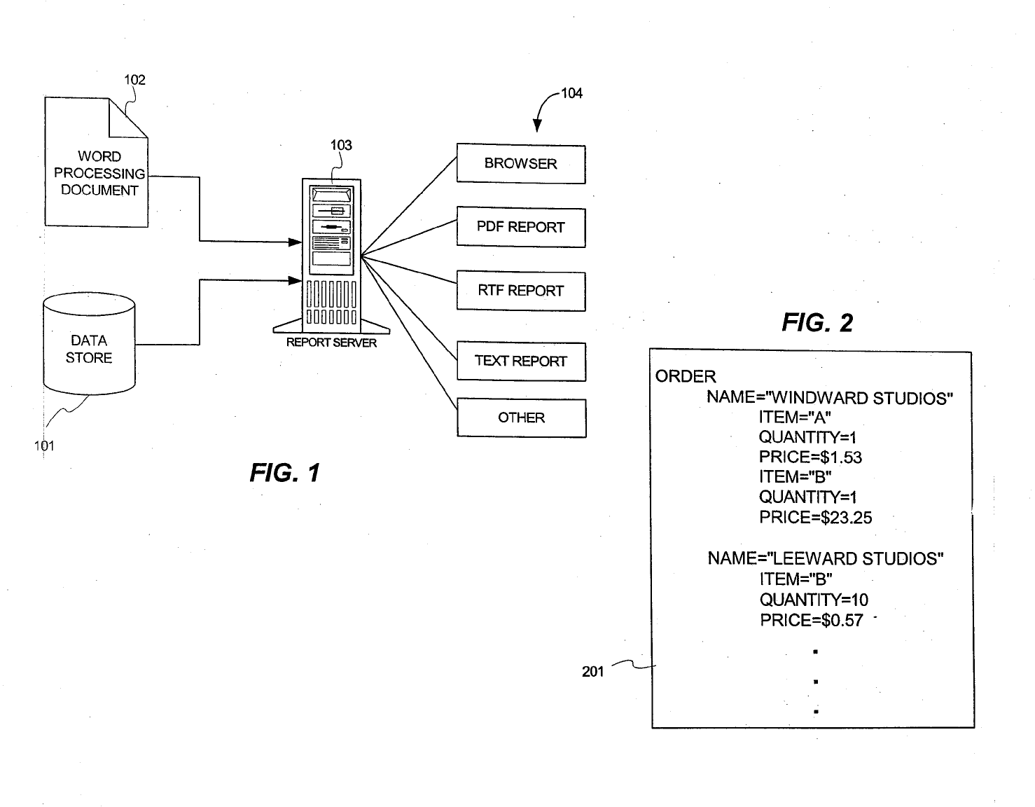

In a particular example, the present invention uses an xml file 201, an example of which shown in FIG. 2, stored in an data store 101 (shown in FIG. 1) which is used as a data source. A document 102 is created using word processing software and saved as an industry standard format such as rich text format or RTF. Report server 103 uses both the word processing document 102 and data source 201 in combination to generate one or more reports 104. In general, the formatting and presentation specifics of the reports 104 are determined by the document 102 while the data content of the reports 104 is determined by the data source 201 within data store 101.

In the particular implementation, data is selected using XPath when the data source is an xml file 201. Alternatively, it is contemplated that data store 101 may be implemented using any data storage technology including relational databases such as SQL, object oriented databases, object relational databases, flat files and the like. Generally, a data store 101 is viewed as modeling an xml file even when the actual implementation of the data store 101 is a non-XML file such as an SQL database. In other words, irrespective of the data store implementation it is viewed as a collection of nodes where each node has one parent and 0 to N children. These nodes can be found and selected via a select statement of some type where the form of the select statement will ordinarily be specific to the actual implementation. The root node has no parent.

Although this feature of the present invention is somewhat non-intuitive, in practice almost all data can easily fit this model. In the case of SQL, any 1:1 and 1:many relationship in the data fits it perfectly. Many:1 also works fine as long as you view the “1” part is viewed as the parent node. Many:many relationships may be more difficult to adapt to the model of the present invention, but are generally able to be handled although the select statements become more complex.

The present invention is independent of the physical implementation of data store 101. Data store 101 may be directly connected to report server 103 and/or attached by a network, and may be implemented as single computer system or as a distributed database spanning several computer systems.

In these alternatives, a data provider accesses data from a corresponding data store 101 in response to a report tag placed in document 102. Selected data from xml file 201 is merged into the report template 102 using report server 103. Data in xml file 201 is selected in the template 102 using, for example, XPath statements that are implemented by report server 103. XPath is the syntax used by XSLT and Xpointer to identify nodes in an xml file. XPath uses the form “/element1/element2” to identify a node. XPath is a simple yet powerful syntax that allows for both absolute and relative selection of elements. Report server 103 generates any number and variety of reports 104 in a format selected by the report designer for presentation of the selected information. Once a report is designed and captured in a report template 102, the reports 104 can be generated at any time.

Templates 102 are designed in an available word processor such as Microsoft Word. The template can use most Word formatting features. In this manner, the report designer sees and controls precisely what the report will look like. In the template, the user can also include “reports tags” in accordance with the present invention. The report tags are included in document 102 at locations where data from xml file 201 will appear in the report. These report tags are placed anywhere in the Word document. Report tags comprise, for example, well-formed xml tags. This means that the report tags take the form of either:

<wr:tag attr1=“value” attr2=“value”/>

or

<wr:tag attr1=“value” attr2=“value”>...</wr:tag>

Each report tag is defined to either be of the first form (empty tag) or the second form (start and end tag). In the examples provided herein each tag includes a namespace designator “wr”, indicating Windard Reports, however, the namespace designation may vary in various implementation and may be omitted in other implemetnations. The attr1=“value” comprises a single attribute and its value or a series of attributes and their values. The values are surrounded with either single or double quotes.

Each report tag has specific attributes. Some are required and the report writer 103 should throw an exception when a required attribute is missing. Other tags are optional in which case a exception need not occur. When an attribute is included in a tag that the tag does not recognize, the report writer 103 should throw an exception.

In most of the tags there is an attribute (usually a select attribute) that defines the node or element from data store 101 that the tag is to use when a report is generated. An exemplary set of report tags and their description includes:

<wr:forEach...>is used to iterate through a set of nodes. The standard usage is:

<wr:forEach select=“./name”>
... other text ...
</wr:forEach>

which will include a portion of the template 102 denoted “other text” (which may itself include any number of report tags) between the “forEach” and the “/forEach” once for each node that satisfies the select=“/name” criteria. The “forEach” tag is by definition, equivalent to a <wr:if...>for 0 or 1 nodes.

An exemplary list of attributes for the forEach tag includes:
select—required—the nodes that will be walked through, one per iteration.
var—optional—identifies the node being stepped through. This can be used in other tags using ${name}. Each implementation can also optionally have ${name.item} where item is a way of describing data returned by this node.
varStatus—optional—returns index, first, last, count for the loop iteration. This can be used in other tags using ${name.*} as follows:
   ${name.index}—the index in the collection of the item returned. This is 0-based and identifies the underlying element regardless of begin and step. For example, if begin=“3” then the first value of index will be 3.
   ${name.count}—the number of elements returned so far. This is 1-based and only counts elements actually returned (unlike index which includes all elements including those not returned.)
   ${name.first}—returns true() if on the first element to be returned. Otherwise returns false().
   ${name.last}—returns true() if on the last element to be returned. Otherwise returns false().
begin—optional—Element to start with. 0 based. (default: 0)
step—optional—process every step element. (default: 1)
   end—optional—Element to end with (processes this element). (default: number of elements)
column—optional—If true then does a column while instead of a row while. (default: false)

A complex example of usage is:

<wr:forEach =“./name” var=”items” varStatus=”stat” begin=”2” step=”3”
end=”10”>
... template text ...
<wr:out select=”${items}/first”/>
<wr:if test=”${stat.first}”>The first person is:</wr:if>
<wr:if test=”${stat.count} == 2”>The second person is:</wr:if>
</wr:forEach>

The above will return the 2^{nd}, 5^{th}, and 8^{th} nodes that match “./name”. The out will return the node “./name/first”. The first if will only print the first time and the second it will only print the second time.

<wr:html...>Implements output formatting based on a node. The full usage is <wr:html select=“./name”/> which will read the text in the referenced node and intelligently parse it for known html tags. It will then apply the formatting of the html tags.

An example of standard usage is:

<wr:html select=“./name”/>

Three items to keep in mind:
1. html select only understands a small subset of html and will ignore any other tags,
2. html select be used for any report type—not just html reports, and
3. html select formatting change only holds until there is another formatting change in the template—and the start of a paragraph is always a formatting change.

An exemplary list of attributes is:
select—identifies the node whose text will be substituted in.

The html that the html select tag understands includes:
<b> and </b>—bold on and off
<i> and </i>—italic on and off
<u> and <u>—underline on and off
<font color=“13579a” size=“12” face=“Courier”>—font control. Color, size, and face are all optional (although without at least one it makes no sense). Color must be in hex (no preceding #) and size is in points.

<wr:if...>Conditionally includes a part of a report. The if tag is unique in that it has two different meanings depending on which attribute is included. You must have either a select= or a test=attribute. You cannot have both.

For <wr:if select=“./name”>...</wr:if> the if tag is performing an if on the dataset. The if tag looks for the existence of the node identified by the select and is true if the node exists and false if it does not. If the attribute notEmpty=“true” is set, the node must not only exist, but must have data in it.

For <wr:if test=“${stat.index}>1”>...</wr:if> the if tag is performing a boolean evaluation on the test attribute. In this case it is not hitting the datasource. However, the use of ${name.item} type fields in the boolean expression allows the evaluation to be performed against var's from forEach and query tags and varStatus' from forEach tags.

The full usage is

<wr:if select=“./name”>
... other text ...
<wr:else/>
... other text ...
</wr:if>
or:
<wr:if select=“./name” notEmpty=”true”>
... other text ...
<wr:else/>
... other text ...
</wr:if>
or:
<wr:if test=“${stat.first}”>
... other text ...
<wr:else/>
... other text ...
</wr:if>

which will include the template between the if and the else if the referenced node exists and will include the text between the else and the end if it does not.

The <wr:else/> is optional and in that case everything is skipped if the node does not exist. The <wr:else/> is only valid inside an if tag there can be only one else tag, and it must be a complete tag (i.e. have the final “/>”).

An exemplary list of attributes is:
select—required (unless test is defined)—the node that will be tested for existence. An empty node exists.
notEmpty—optional (only used with select)—the node must exist and must not be empty.
test—required (unless select is defined)—the boolean statement to evaluate.

An exemplary set of operators allowed in the test=.″″ attribute is shown in Table 1.

TABLE 1

| | |
|---|---|
| ( ) | |
| + | |
| − | |
| * | |
| / | div |
| % | mod |
| == | eq |
| != | ne |
| < | lt |
| > | gt |
| <= | le |
| >= | ge |
| && | and |
| ∥ | or |
| ! | not |

For variables it handles Boolean (the text true or false—no quotes), long, double, and String. Strings must be in quotes and it handles \″ inside a string (but no other escape sequences).

<wr:import...>Imports an external file. The normal usage is:

<wr:import url=“./name”/>

The import tag will read the value from the node and will assume that the read in value is a filename. The import tag will then read in that file. The import tag uses the file extension to determine what type of file is being imported unless overridden with the type attribute. Acceptable file extensions are:
.jpg, .jpeg—JPEG bitmap file.
.png—PNG bitmap file.
.txt—ASCII text file.
.rtf—RTF file. This will include styles, fonts, colors, etc. who's index is not in the base template. But for document header table entries which have the same index, the values in the base template will be used.

An exemplary list of attributes are:
url—required—the node that will be read for the filename.
type—optional—The file type (ignore the file's extension). Example file type values are: JPG, PNG, TXT, and RTF.
source—optional—The url will ordinarily be read in the order;

1. Thread.currentThread().getContextClassLoader(),

2. ProcessReport.class.getClassLoader(),

3. ClassLoader.getSystemResource(propFile), and

4. as a file.

By setting the value of the source attribute, the order can be forced. When set, the import tag will only try the specified source. Allowed values are:

THREAD
APP-CLASS
SYSTEM-CLASS
FILE

An example of complex usage is:

.<wr:import url=“./name” type=“JPG” source=“FILE”/>

<wr:link...>Creates a hyperlink from a node. The full usage is:

<wr:link url=“./name”>
... other text ...
</wr:link>

which will include the template between the link and the end as the hypertext in the report. An exemplary list of attributes is:
url—required—the node whose value will be set as the url for the hyperlink.

<wr:out...>Displays the contents of a node. The simple usage is:

<wr:out select=“./name”/>

which will replace that tag with the text in the referenced node in the final report. An exemplary list of attributes are:

select—required—the node whose text will be substituted in.
default—optional—the text to substitute in if the node does not exist. This is not used if the node exists but is empty.
type—optional—This involves the use of NumberFormat & DateFormat. This attribute defines both how the text in the node is parsed and how it is displayed. In both cases it uses the report locale to parse and display the text. Numbers are parsed using DecimalFormat.parse(). Date/time can be in the SHORT, MEDIUM, LONG, or FULL format. They can also be a long used in the constructor for the Date class. Allowed values are:
   NUMBER—will display in the locale equivalent of 123,456.78
   CURRENCY—will display in the locale equivalent of $123,456.78 and ($123,456.78)
   PERCENT—will display in the locale equivalent of 55%
   DATE—will display the date in the locale specific format. The node does not need a time in this case
   TIME—will display the time in the locale specific format. The node does not need a date in this case
   BOTH—will display the date & time in the locale specific format.
   BITMAP—the node data is assumed to be a uuencoded string of a file image for a jpeg or png bitmap file. It will be uudecoded, read in as a bitmap, and placed in the report.
pattern—optional—In the case of NUMBER/CURRENCY/PERCENT, pattern is passed to DecimalFormat.applyPattern(). In the case of type=DATE/TIME/BOTH, this pattern can be used two different ways. If it has the value SHORT, MEDIUM, LONG, or FULL, then it will pass that value in to DateFormat and return the standard date/time/both for the locale. If it has any other value, the pattern is passed to SimpleDateFormat and that class is used to format the text returned.

Several attempts are made to parse the input string. Parsing refers to when report generator 103 reads the text in the xml element and attempts to determine its value). For a number/currency/percent, the report generator first attempts to parse the string using the appropriate NumberFormat.parse() method and using NumberFormat.applyPattern(). If this fails, it then tries Double.parseDouble(). If that fails it will then throw NodeFormatException.

For date/time/both it makes six passes when attempting to parse. First it will try DateFormat.parse() using DateFormat.applyPattern(). If that fails, it will try in order DateFormat.parse() using the patterns FULL, LONG, MEDIUM, and SHORT without using applyPattern(). If that fails it will assume the data is a long and try Date (Long.parseLong(). If it is not a long, it will throw a NumberFormatException.

An example of complex usage is:

<wr:out select=“./name” default“00/00/00” type=“DATE”/>

<wr:query...>Sets a variable that is a node for later use. This outputs nothing, it just creates a local variable that can be referenced using ${name} later in other tags. It provides the ability to use the equivalent of the C# use construct. The purpose of this tag is to create a node that can be referenced by other tags.

The full usage is

<wr:query select=“./name” var=“name”/>

which will evaluate the value as a node in the data and store the result in var. If the select makes use of a var in a forEach tag, then this var is still good when the forEach loop is exited.

To delete a query, call query select with a query that is a 0 length string—<wr:query select=″″ var=“name”/>.

An exemplary list of attributes is:
select—required—the text that will be evaluated to a node.
var—required—identifies the node. This can be used in other tags using ${name}

<wr:escape...>Outputs anything in the final report. The full usage is

<wr:escape select=“./name” type=“rtf”/>

which will place the text in the referenced node in the final report exactly as is. Windward Reports does not parse the string and has no idea what it is doing.

An exemplary list of attributes is:
select—required—the node whose text will be substituted in.
type—required—the report type that this will be substituted in on. The allowed values are ALL, RTF, HTM, and TXT. (pdf files are not stream based and therefore an escape makes no sense in them.)

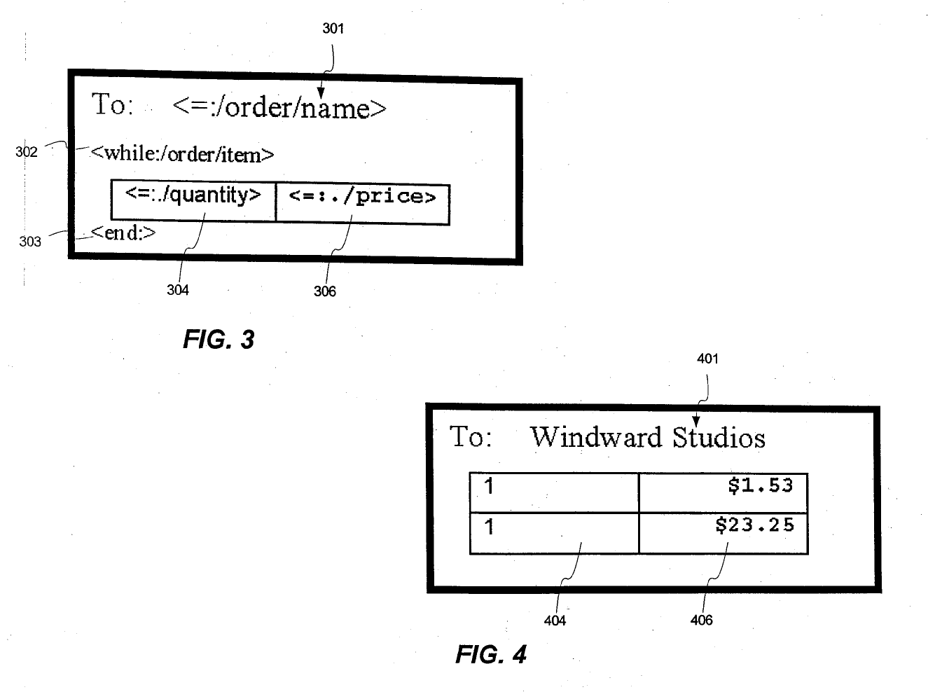

FIG. 3 shows an exemplary template, while FIG. 4 illustrates an exemplary report generated using the template of FIG. 3. In the template, element 301 comprises an “xpath” tag that is replaced by the text for the xpath element, which in the example is the text “Windward Studios”. When the report is generated “Windward Studios” appears in the designated location as shown at 401 in FIG. 4. Tag 301 makes reference to an xml data file 201 or node within a data file named “order”. Within that file or node is one or more subnodes named “name”, each of which have a value. In the particular example, each node has a value indicating the name of a customer or account.

Tag 302 defines a command tag that, in combination with command tag 303, will cause report server 103 to extract data from xml file 201 for each order and item having a value in xml file 201. For each order and item, the values of “quantity” and “price” are extracted and placed in the report at the locations 404 and 406 in FIG. 4, as specified by tags 204 and 306 in the template. It can be appreciated that more complex selection logic may be incorporated in the command tags, and that the report template shown in FIG. 3 may include any number and variety of tags to implement reports of arbitrary complexity.

In a particular example, the present invention is implemented using a Java™ archive (“.jar”) format file (named “WindwardReports.jar” in a specific example) that enables multiple files to be bundled into a single archive file. Typically, the JAR file will contain the class files and auxiliary resources associated with applets and applications used by the present invention. The present invention can be incorporated into a server by including the WindwardReports.jar in the classpath. The present invention may rely on third party libraries such as the log4j (public domain software that enables logging at runtime without modifying the application binary) and dom4j (an open source XML framework for Java. that enables reading, writing, navigating, creating and modifying XML documents and provides XPath support, in which case these third party libraries should be included in the classpath as well.

Once a report template is created, it is saved as an rtf file in the particular implementation. The report template is then merged with an xml data file to create a final report, with all of the formatting and positioning as set in your original template. This final report can be written as html (3.2), html (with .css), pdf, rtf, or txt.

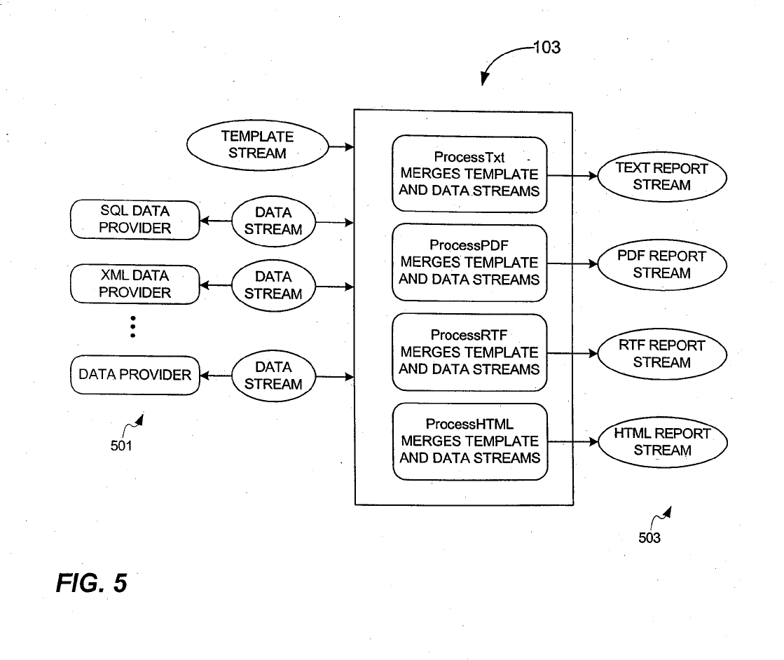

FIG. 5 illustrates an implementation of a report server 103 in greater detail. In the particular implementation, an abstract class named “ProcessReport” is a base main program from which subclasses including “ProcessTXT”, ProcessPDF, ProcessHTML and Process RTF are derived. Instances of the subclasses function to take a template stream from template 102 and one or more data stream s from one or more data sources such as providers 501, and merges them to create one or more report streams 503. Each of the subclasses is designed to handle a specific type of report output, and any variety of output report formats can be implemented to meet the needs of a particular application.

The present invention allows the use of multiple data sources in a single report job when processing a template. In this case, the template is processed with one data source creating an intermediate file. This intermediate file retains all tags that did not match data in the first data source. The intermediate file is then processed a second time with a second data source (e.g., a provider 501). This second processing produces another intermediate file. This Processing can be repeated any number of times. The final data source is marked as final and only when processing that final data source does the report generator handle missing nodes as missing instead of keeping them in the document.

Calling the report services in accordance with the present invention generally involves a few lines of code. For example:
ProcessReport report=new ProcessPdf(
new FileImputStream(“order.xml”),
new FileImputStream(“template.rtf”),
new FileOutputStream(“report.pdf”)); report.process();

The object created (i.e., ProcessReport) is different depending on the report type desired. And each report type has various options that can be set. But in most cases the main work is determining the file names to be passed in for the two input and the one output file. In the particular example, the I/O to the API is via streams. In this manner, files do not have to be passed. Input can be strings, data in a SQL database, or any other source.

Reports 104 can be returned in html, pdf, rtf, text, or other format useful for a particular application. The html format can be returned as a complete page, or as a block of html text that can be placed within the body of a page along with other body text. It can use cascading style sheets (either inline or externally referenced) or not. The specific version of the popular browsers can be set and the report will only use tags supported by that version of that browser. Finally, the present invention has a “Keep It Simple” mode where tag use will be kept to a minimum, and the report will follow the spirit of the template, but may not match it exactly. The pdf format returns an Adobe Acrobat document. The generated document can be set to use Acrobat fonts only (small file) or to use the fonts specified in the template (large file with embedded fonts). The rtf format returns a Rich Text Format file that can be read by virtually all word processors. The txt format returns an ASCII file that is just the text from the report. Text files contain no formatting except for a <CR> at the end of each line.

The present invention is implemented as a set of API calls. Therefore, there is no separate server that must be installed, configured, and monitored. All the calling server needs to do is make the calls. Preferably, the invention is implemented in a form that is fully reentrant and thread-safe. Therefore, it can generate numerous reports simultaneously.

It will be appreciated that the present invention as described above allows an end user to create new reports and/or edit existing reports without having to wait for a reporting expert. This again saves time and money while providing a better service to the users of a system that involves reporting. By leveraging the full formatting power of Word as well as having a true. WYSIWYG design tool, even programmers and reporting experts find the present invention to be a much faster system for creating reports. No longer will creating reports be weeks of scripting with iterative feedback. Instead it becomes a matter of hours.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A system for generating reports from a data source comprising:
a first interface operable to receive an input stream comprising a text document having report tags embedded therein;
a second interface for communicating streams of data with a data source;
a third interface for generating an output stream comprising a formatted report that integrates data selected from the data source according to the report tags with the text document to define the formatted report.

2. The system of claim 1 wherein the formatted report can be formatted in one or more formats selected from the group consisting of: hypertext markup language, portable document format, rich text format, text, and multi-part MIME.

3. The system of claim 1 wherein the second interface is configured to communicate the streams of data with a data source selected from the group consisting of: flat files, relational databases, object oriented databases, and object relational databases.
